(19) United States
(12) Patent Application Publication
(10) Pub. No.: US 2014/0080554 A1
(43) Pub. Date: Mar. 20, 2014

(54) Combine Harvester Grain Cleaning Apparatus

(71) Applicant: Morten Leth Bilde, Langaa (DK)

(72) Inventor: Morten Leth Bilde, Langaa (DK)

(73) Assignee: AGCO A/S, Randers (DK)

(21) Appl. No.: 13/979,147

(22) PCT Filed: Dec. 15, 2011
(86) PCT No.: PCT/EP2011/073001

§ 371 Date: Nov. 25, 2013

(30) Foreign Application Priority Data
Jan. 11, 2011 (GB) 1100411.6

(51) Int. Cl. A01F 7/04; A01F 12/44

(52) U.S. Cl. CPC A01F 7/04; A01F 12/44; A01F 12/444; A01F 12/446
USPC 460/73; 460/75

(57) ABSTRACT

A combine harvester (10) comprises a transverse threshing unit (26) arranged to receive and thresh a crop stream. Separating apparatus (32,36) are located downstream and rearward of the threshing unit and arranged to receive the threshed crop stream and convey in a rearward direction. Both the threshing unit and separating apparatus comprise respective grates (34, 42) for allowing grain and chaff to fall under gravity onto an underlying thresher pan (28) and separator pan (44) respectively. The thresher pan is driven in an oscillating manner to convey a primary grain/chaff stream rearwardly to a rear edge (49) from where the primary grain/chaff stream fails under gravity into a cleaning unit (48). The separator pan is also driven in an oscillating manner to convey a secondary grain/chaff stream forwardly to a front edge from where the secondary grain/chaff stream falls under gravity to combine with the primary grain/chaff stream. The cleaning unit comprising a fan (52) for generating a cleaning airstream (X,Y) which is directed through the falling grain/chaff stream. The separator pan front edge is disposed forwardly of the thresher pan rear edge by an overlap distance such that the secondary grain/chaff stream falls onto the thresher pan and stratifies before falling off the rear edge thereof.

### CROSS-REFERENCE TO RELATED APPLICATION

The present application claims the benefit of and priority from United Kingdom Application No. 1100411.6, filed Jan. 11, 2011, the entire disclosure of which is hereby incorporated by reference.

### FIELD OF THE INVENTION

The invention relates to the processing of a crop stream in a combine harvester and more particularly to the means to convey grain and chaff separated from the straw to a cleaning unit.

### BACKGROUND

For many decades, self-propelled combine harvesters have been used by farmers to harvest a wide range of crops including cereals, maize and oil-seed rape. Typically, a combine harvester cuts the crop material, threshes the grain therefrom, separates the grain from the straw, and cleans the grain before storing in an onboard tank. Straw and crop residue is ejected from the rear of the machine.

Combines of the transverse threshing type comprise a threshing cylinder which rotates on a transverse axis and serves to thresh a harvested crop stream. Grain and chaff separated in this process falls under gravity through a grate onto an underlying thresher pan which is driven in an oscillating manner to convey the grain and chaff rearwardly to a rear edge from where the grain and chaff falls under gravity into a cleaning unit. The remainder of the crop stream from the threshing process is conveyed rearwardly from the threshing cylinder into separating apparatus which may include a plurality of straw walkers or one or more axial rotors. During the separating process further grain and chaff is removed from the straw and falls under gravity through a grate onto an underlying separator pan which is also driven in an oscillating manner to convey the grain and chaff forwardly to a front edge from where it falls under gravity into the cleaning unit. The straw by-product from the separating apparatus is ejected from the rear of the combine.

The cleaning unit of most combines operates according to a well-established process in which grain and chaff cascading down from the thresher and separator pans is subjected to an airstream created by a fan. The airstream blows the lighter chaff and dust rearwardly and out of the combine whilst the heavier grain falls onto and through a series of cleaning sieves before being conveyed to the grain tank.

The speed of the airflow is chosen so as to maximise the percentage of chaff removed from the crop-stream whilst minimising the percentage grain loss from the rear of the machine.

Developments in threshing and separating technology of recent years have not been matched by an increase in capacity of the cleaning unit. The bottleneck presented by the cleaning unit therefore inhibits utilisation of the full potential of modern separating technology.

### SUMMARY OF INVENTION

It is, therefore, an object of the invention to improve the cleaning process in combine harvesters to alleviate this bottleneck.

In accordance with the invention there is provided a combine harvester comprising a transverse threshing unit arranged to receive and thresh a crop stream, separating apparatus located downstream and rearward of the threshing unit and arranged to receive the threshed crop stream and convey in a rearward direction, both the threshing unit and separating apparatus comprising respective grates for allowing grain and chaff to fall under gravity onto an underlying thresher pan and separator pan respectively, the thresher pan being driven in an oscillating manner to convey a primary grain/chaff stream rearwardly to a rear edge from where the primary grain/chaff stream falls under gravity into a cleaning unit, the separator pan being driven in an oscillating manner to convey a secondary grain/chaff stream forwardly to a front edge from where the secondary grain/chaff stream falls under gravity to combine with the primary grain/chaff stream, the cleaning unit comprising a fan for generating a cleaning airstream which is directed through the falling grain/chaff stream, wherein the separator pan front edge is disposed forwardly of the thresher pan rear edge by an overlap distance such that the secondary grain/chaff stream falls onto the thresher pan and stratifies before falling off the rear edge thereof.

The invention involves the recognition that grain and chaff falling from the rear edge of the thresher pan is more stratified than the grain and chaff falling into the cleaning unit from the separator pan. It has been observed that the rearward conveyance of the grain and chaff along the surface of the thresher pan causes the grain/chaff stream to stratify wherein the lighter chaff material rises to the top whilst the heavier grain sinks to the bottom. As this stratified grain/chaff stream cascades from the rear edge of the thresher pan the chaff blown by the airstream can move rearwardly without obstruction. This process can be contrasted to the grain/chaff stream conveyed into the cleaning unit of known combines from the separator pan. In machines where the grain and chaff from the separator pan passes directly into the cleaning unit, the stream may by stratified so as to have a detrimental effect on the chaff/grain separation from the airstream in that the rearward passage of the lighter chaff must pass through the falling grain. In known machines in which the forwardly conveyed grain and chaff from the separator pan falls onto the thresher pan due to a short overlap, the grain and chaff has no time to stratify and falls into the cleaning unit as a grain/chaff mixture.

By providing a significant overlap between the thresher pan and separator pan the grain and chaff conveyed forwardly by the separator pan falls on top of the grain and chaff discharged by the threshing cylinder on the threshing pan. The combined material streams are then conveyed rearwardly by the thresher pan whilst giving time (or distance) to stratify before falling from the rear edge thereof into the cleaning unit.

Advantageously, the better stratified grain and chaff stream falling into the cleaning unit increases the capacity of the cleaning unit thereby relieving the bottleneck and increasing the throughput of the overall combine. Furthermore, the cleaning process is improved creating a better grain sample.

The overlap distance is preferably between one third and two thirds of the distance that the primary crop stream is conveyed by the thresher pan. The overlap between the separator pan and the thresher pan need be sufficient to provide enough time and distance for the separator material to stratify before delivery to the cleaning unit. However, excessive overlap leads to unnecessary conveyance of the grain and chaff from the separator and can also cause interference with the stratification process of the primary crop stream from the thresher. In view of this, the overlap distance is preferably within the range of 600 to 1000 millimetres and more preferably within the range of 700 to 900 millimetres.

The combine harvester may further comprise a transverse transfer beater for conveying the threshed crop stream into the separating apparatus. The transfer beater may comprise an underlying grate for allowing grain and chaff to fall under gravity onto the underlying thresher pan. Alternatively, a smooth solid sheet may be provided depending on the crop being harvested. The separator pan front edge is preferably disposed no further forward than the swept envelope of the transfer beater. The extended separator pan as a result does not significantly affect the grain and chaff falling from the transverse beater, but allows enough overlap for sufficient stratification of the separator material. The grain/chaff mixture falling from the transverse beater typically has a higher proportion of grain than that from the separator pan. This material preferably falls directly onto the thresher pan thereby allowing the lighter grain/chaff mixture from the separator pan to fall on top thereof.

The separating apparatus may comprise a pair of longitudinally aligned separating rotors as is common in hybrid separation technology. Alternatively, the separating apparatus may be of the conventional form, comprising a plurality of straw-walkers, typically six or eight.

In a preferred arrangement, the separator pan comprises a first portion suspended from a combine frame by front and rear suspension means, and a second portion disposed forwardly of the first portion, and pivotally mounted to the frame at the forward end, wherein a rear edge of the second portion is releasably attached to a front edge of the first portion, the second portion being pivotable around the forward mounting around a transverse axis between an operating position in which the second portion is attached to the first portion forming a continuous pan surface, and a lowered position in which the second portion is detached from the first portion to give maintenance access to the underside of the separating apparatus.

### BRIEF DESCRIPTION OF THE DRAWINGS

Further advantages of the invention will become apparent from reading the following description of specific embodiments with reference to the appended drawings in which:

FIG. 1 is a side elevation of a combine harvester in accordance with the invention;

FIG. 2 is a sectional view through the crop processing apparatus of the combine harvester of FIG. 1;

FIG. 3 is a perspective view showing part of the crop processing apparatus of FIG. 2 showing the front portion of the separator pan in an operating position;

FIG. 4 shows the same view as FIG. 3 but with the front portion of the separator pan in a lowered position;

FIG. 5 is a perspective view of the underside of the rear portion of the separator pan; and,

FIG. 6 is a perspective external view of the separator pan drive mechanism.

### DESCRIPTION OF EXAMPLE EMBODIMENT

From reading the following description it should be understood that the terms longitudinal and transverse are made in relation to the combine harvester's normal direction of travel. In other words, the term ‘longitudinal’ equates to the fore and aft direction, whereas the term ‘transverse’ equates to the crosswise direction, or left and right. Furthermore, the terms ‘axial’ and ‘radial’ are made in relation to a rotating body such as a shaft wherein axial relates to a direction along the rotation axis and radial equates to a direction perpendicular to the rotation axis.

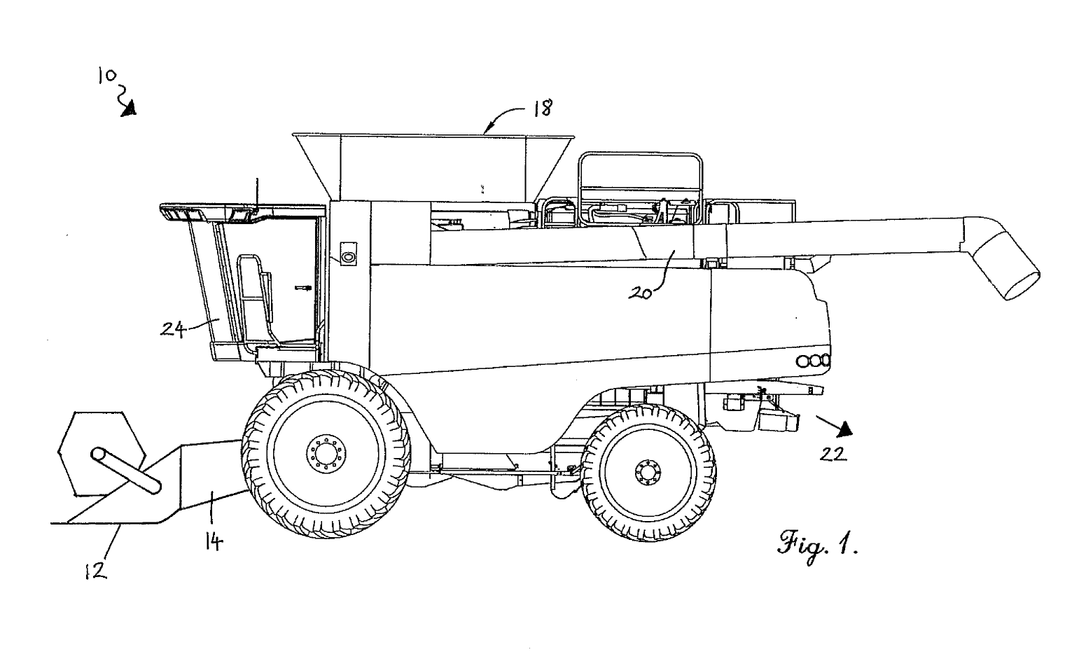

With reference to FIG. 1, a self-propelled combine harvester 10 comprises a header 12 which cuts and gathers a strip of crop as the combine harvester is driven across a crop field. An elevator section 14 conveys the crop stream from the header 12 into a central processing apparatus 16 described in more detail below. Clean grain separated from the crop stream is collected in a storage tank 18 which is periodically emptied into a trailer (not shown) via an unloading auger 20. Residue material remaining from the crop stream such as straw and chaff is ejected from the rear of the machine represented by arrow 22. For completeness the combine 10 includes a driver's cab 24.

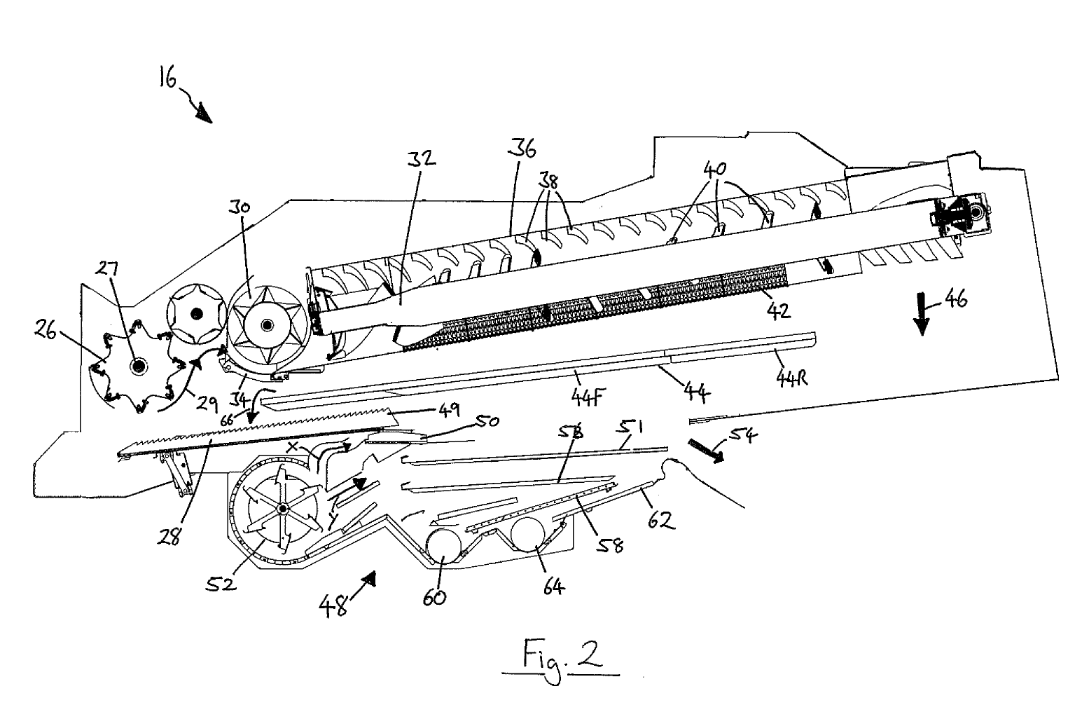

Turning to the details of the crop processing apparatus 16, as shown in FIG. 2, the crop stream passes from the elevator 14 into a threshing unit 26 in the form of a transverse threshing cylinder which rotates in a counter clockwise direction as seen in FIG. 2 around a transverse axis 27. As in known combines the crop stream is threshed between the threshing cylinder 26 and a concaved surface (not shown). Grain and chaff separated in this process falls through a grate in the concave onto an underlying thresher pan 28 forming a primary grain/chaff stream. The residue straw is conveyed rearwardly as represented by arrow 29 from the threshing unit to a transverse transfer beater 30 which also rotates counter clockwise as viewed in FIG. 2. From here the crop stream is divided into two sub-streams and passed into respective longitudinally-aligned separating rotors. It will be appreciated that only one rotor 32 is shown in FIG. 2. The transfer beater 30 has associated therewith a concave grate 34 through which further grain and chaff may fall under gravity onto the underlying thresher pan 28.

The separator apparatus in this case comprises a pair of longitudinal rotors 32, which rotate around a substantially longitudinal axis as in known axial and hybrid combines. Each separating rotor 32 has associated therewith a substantially cylindrical cage 36 within which the rotor rotates. Upon the inside upper peripheral surface of the rotor cages 36 a plurality of guide vanes 38 are mounted for cooperation with fingers 40 mounted to the rotating rotor 32 which together separate the remaining grain from the stream of straw. The lower portion of each cage 36 has a grate 42 formed therein which allows separated grain and chaff to fall under gravity onto an underlying separator pan 44 forming a secondary grain/chaff stream.

The residue straw is ejected from the process apparatus 16 at the rear of the rotors 32 as indicated by arrow 46.

Although the above described separating apparatus comprises a pair of longitudinal rotors operating on the axial separation principle, it is envisaged that these may be replaced with straw walkers known in conventional combines without deviating from the scope of the invention.

Both the thresher pan 28 and separator pan 44 are driven in an oscillating manner known in the art so as to convey the respective grain/chaff streams rearwardly and forwardly respectively. The drive mechanism for the thresher pan 28 and separator pan 44 will be described in more detail below.

After falling onto the thresher pan 28 the primary grain/chaff stream is conveyed rearwardly by the oscillating motion. During conveyance the grain and chaff is stratified meaning that the heavy grain sinks to the bottom of the material layer and the lighter chaff rises to the top. This stratification of the material is of great importance and has a significant positive influence on the following cleaning process executed by the cleaning unit 48. To explain this further the stratified grain and chaff stream falls under gravity from the rear edge 49 of the thresher pan 28 into the cleaning unit 48. The grain and chaff initially falls onto a cascade pan 50 before falling from the rear edge thereof onto a first sieve 51.

A fan 52 generates a cleaning airstream, a portion of which is directed rearwardly between the thresher pan 28 and cascade pan 50 as represented by arrow X. The aforementioned stratification allows the lighter chaff to be blown rearwardly and carried by the airstream out of the rear of the machine as represented by arrow 54 in an uninterrupted manner whilst the heavier grain falls onto the cascade pan 50.

Without the stratification higher velocity airflow would be required to carry an equivalent proportion of chaff from the crop stream resulting in a higher grain loss. It will be appreciated by the skilled person that such stratification process increases the overall capacity of the cleaning unit 48.

The crop stream falls from the rear edge of the cascade pan 50 onto the first sieve 51 as described above. A further airstream represented by arrow Y is directed rearwardly between the cascade pan and first sieve 51 and also between the successive sieves. Again, the cascading motion of the grain and chaff allows the airstream Y to convey further chaff to the rear of the cleaning unit. First sieve 51 is coarser (with larger holes) than second sieve 56 which is located under first sieve 51.

First sieve 51 and second sieve 56 are driven in an oscillating manner. Straw and material which is too large to pass through first sieve 51 is conveyed rearwardly by the oscillating motion before falling from the rear edge and out of the rear of the combine.

Tailings, or unthreshed grain, and grain passes through first sieve 51 onto second sieve 56. Grain falls through second sieve 56 onto an underlying collection pan 58 which directs the clean grain to a transverse delivery auger 60 for delivering the grain to the storage tank 18.

The tailings which cannot pass through the holes in second sieve 56 are conveyed rearwardly by the oscillating motion before falling from the rear edge of the sieve 56 onto a tailings collection pan 62 which delivers the tailings to a rethreshing delivery auger 64.

In accordance with the invention, the front of the separator pan 44 overlaps with the thresher pan 28 in a vertically spaced relationship. This causes the secondary grain/chaff stream to be conveyed forwardly by a distance so that the secondary crop stream falls onto the, at least partly, stratified primary crop stream on the thresher pan 49 as represented by arrow 66. The secondary grain/chaff stream therefore combines with the primary grain/chaff stream both of which are conveyed together in a rearward direction by the thresher pan 28. Advantageously, this causes stratification of the secondary grain/chaff stream which originates from the separating apparatus. Therefore, the majority of the grain and chaff cascading into the cleaning unit 48 from the rear edge 49 of thresher pan 28 is stratified thereby increasing the capacity of the cleaning unit 48.

The overlap distance between the thresher pan 28 and separator pan 44 is chosen to provide sufficient distance for the secondary grain/chaff stream to stratify whilst not interfering with the stratification of the primary grain/chaff stream. Excessive overlap has been found to reduce the capacity of the thresher pan 28 and it is preferable for the secondary grain/chaff stream to fall upon the primary grain/chaff stream. In this example the overlap is 800 millimetres although it will be appreciated that the optimal overlap will differ from machine to machine. In general the overlap should be at least one third of the distance that the primary crop stream is conveyed by the thresher pan whilst being no more than two thirds of that same distance.

In the test lab the inventor discovered that the length of the separator pan extension is proportional to the increased stratification, which again is inversely proportional to the overall cleaning shoe loss. However, the extension (or overlap) should not be too long so as to interfere with the stratification between the two material streams.

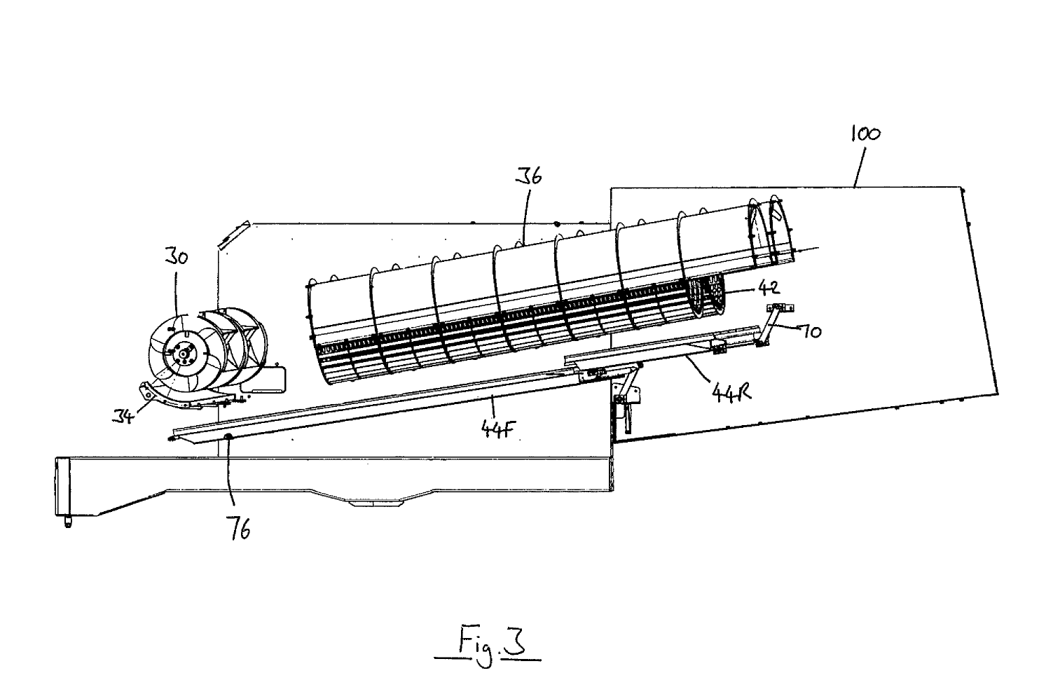

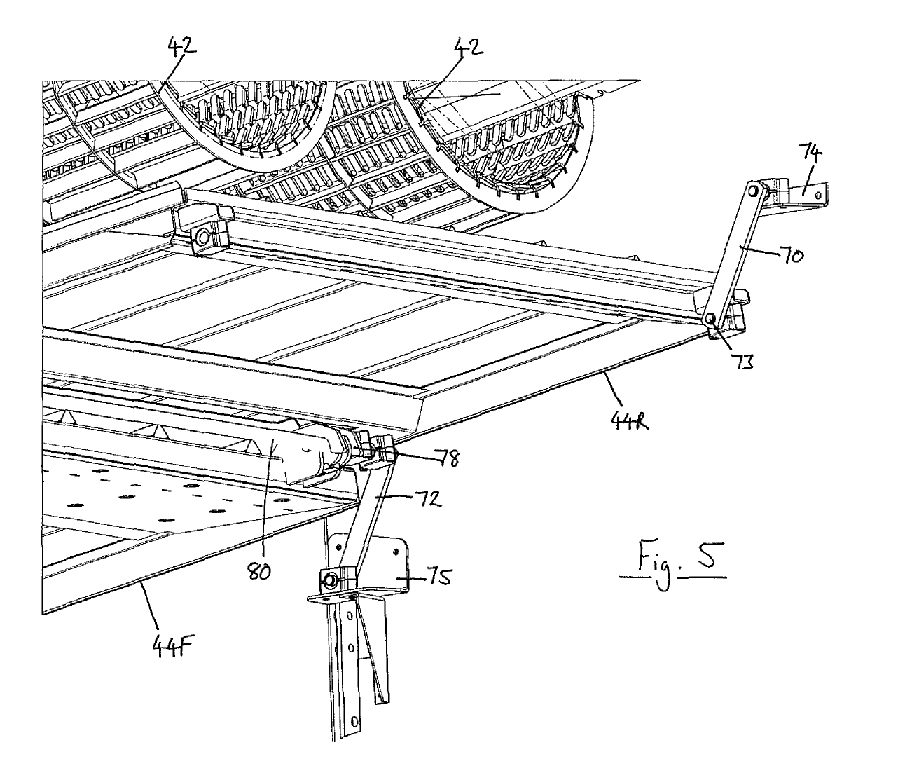

Turning to the construction of the separator pan 44, the overall length is provided by a rear portion 44R and a front portion 44F. The rear portion 44R, as also shown in FIGS. 3 and 5, is suspended from the combine frame 100 by a pair of rear links 70 and a pair of front links 72. It will be appreciated that only one link from each pair is shown in FIGS. 3 and 5 for clarity. With particular reference to FIG. 5, each rear link 70 is pivotally connected to a respective rear corner of the rear portion of the separator pan 44R. The pivotal connection is made by a transverse pin 73 which is inserted into a hole of the rear link 70 at one end. At the distal end of rear link 70 a further pivoting connection is made with a bracket 74 which is secured to the combine frame 100.

Turning attention to the pair of front links 72 a similar construction is adopted in that each link 72 is pivotally connected at one end to a respective front corner of the separator pan rear portion 44R and at an opposite end to a bracket 75 which is secured to the combine frame 100. Together the front links 70 and rear links 72 suspend the rear portion of the separator pan 44R in a manner which allows fore and aft oscillating movement.

It should be understood that the front linkage 70 and rear linkage 72 may adopt a different construction whilst allowing the required oscillating movement of the separator pan 44. For example the rear corners of the rear portion of separator pan 44R may be suspended from below whist the front corners may be suspended from above.

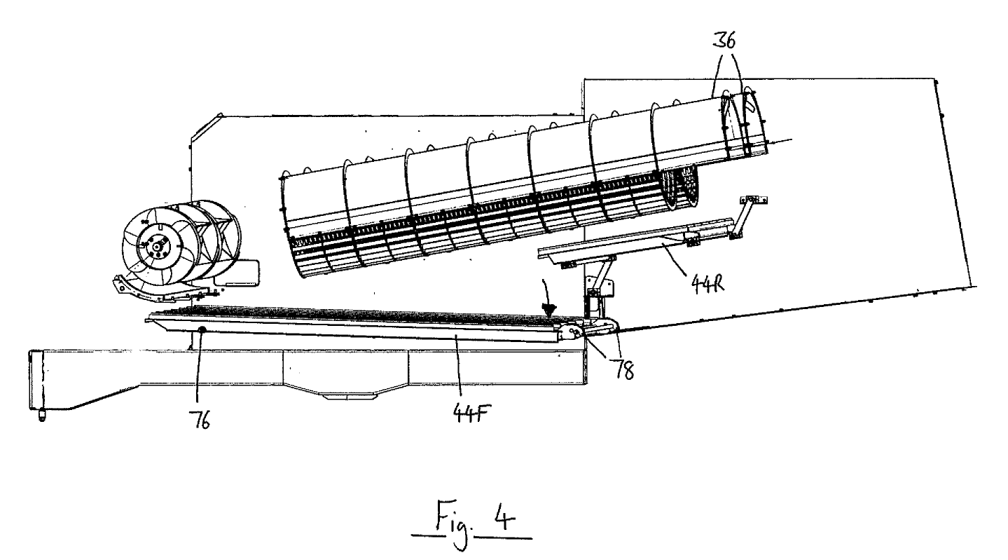

Turning attention to the front portion 44F of separator pan 44 a transverse shaft 76 as seen in FIG. 3 provides a front support for the separator pan 44. The front portion 44F can pivot around the transverse support shaft 76 between an operating position (as shown in FIG. 3) and a lowered position (as shown in FIG. 4). At its rear edge the front portion 44F includes a pair of hooks 78 which engage a transverse bar 80 connected to the rear portion 44R. The hook 78 and bar 80 provide a releasable connection between the rear portion 44R and front portion 44F of the separator pan 44. It will be appreciated that the hooks may be associated with the rear portion 44R whilst the transverse bar may be disposed on the front portion 44F without deviating from the scope of the invention.

The releasable mechanism allows an operator to lower the front portion 44F into the lowered position as shown in FIG. 4 to gain access to the underside of the separating apparatus, in this case the rotor cages 36.

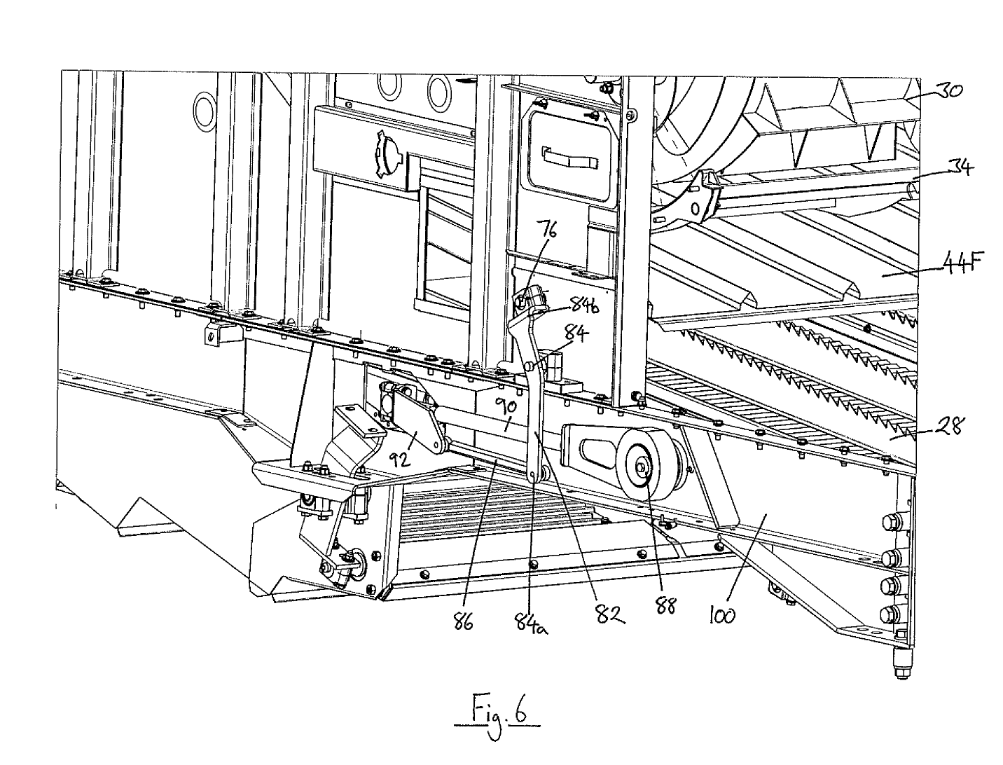

The separator pan 44 receives its drive force from a drive connection with the drive to the cleaning unit. As best seen in FIG. 6, a lever 82 is pivotally mounted at 84 to the outside of combine frame 100. At its driven end 84a the lever is pivotally connected to a first connecting rod 86 which, in turn, is connected at its distal end to a reciprocating drive mechanism attached to the cleaning unit 48. At its driven end 84b the lever 84 is connected to the transverse support shaft 76 which passes through a slot (not shown) in the combine frame.

For completeness, a crankshaft 88 is driven by a belt drive (not shown) which obtains power from the engine. The rotating crankshaft drives a second connecting rod 90 in a reciprocating motion so as to deliver a drive force to the cleaning unit 48. The first connecting rod 86 is pivotally connected to a bracket 92 which is bolted to the second connecting rod 90 so as to obtain the required reciprocating motion for the separator pan drive.

Conveniently, the exterior mounting of lever 84 and associated drive connections allows easy assembly and service access.

Turning back to FIG. 3, the reciprocating motion driving support shaft 76 provides the driving force to cause the entire separating pan 44 to oscillate. It should be understood that the drive force is conveyed to the rear portion 44R via the releasable connection between the two portions and that the rear portion is in fact mounted in a passive manner.

Although shown with a drive mechanism at the front of separator pan 44 it is envisaged that either or both parts of the separator pan 44 may be driven without deviating from the scope of the invention and indeed without losing the advantages provided by a two part construction.

1. A combine harvester comprising a transverse threshing unit arranged to receive and thresh a crop stream, separating apparatus located downstream and rearward of the threshing unit and arranged to receive the threshed crop stream and convey in a rearward direction, both the threshing unit and separating apparatus comprising respective grates for allowing grain and chaff to fall under gravity onto an underlying thresher pan and separator pan respectively, the thresher pan being driven in an oscillating manner to convey a primary grain/chaff stream rearwardly to a rear edge from where the primary grain/chaff stream falls under gravity into a cleaning unit, the separator pan being driven in an oscillating manner to convey a secondary grain/chaff stream forwardly to a front edge from where the secondary grain/chaff stream falls under gravity to combine with the primary grain/chaff stream, the cleaning unit comprising a fan for generating a cleaning airstream which is directed through the falling grain/chaff stream, wherein the separator pan front edge is disposed forwardly of both a front end of the separating apparatus and the thresher pan rear edge by an overlap distance such that the secondary grain/chaff stream falls onto the thresher pan and stratifies before falling off the rear edge thereof.

2. A combine harvester according to claim 1, wherein the overlap distance is between one third and two thirds of the distance that the primary crop stream is conveyed by the thresher pan.

3. A combine harvester according to claim 1, wherein the overlap distance is within the range of 600 to 1000 millimetres.

4. A combine harvester according to claim 3, wherein the overlap distance is within the range of 700 to 900 millimetres.

5. A combine harvester according to claim 1, further comprising a transverse transfer beater for conveying the threshed crop stream into the separating apparatus, the transfer beater comprising a grate for allowing grain and chaff to fall under gravity onto the underlying thresher pan, wherein the separator pan front edge is disposed no further forward than the swept envelope of the transfer beater.

6. A combine harvester according to claim 1, wherein the separating apparatus comprises a pair of longitudinally aligned separating rotors.

7. A combine harvester according to claim 1, wherein the separating apparatus comprises a plurality of straw walkers.

8. A combine harvester according to claim 1, wherein, the separator pan comprises a first portion suspended from a combine frame by first and second suspension means, and a second portion disposed forwardly of the first portion and pivotally mounted to the frame at the forward end, wherein a rear edge of the second portion is releasably attached to a front edge of the first portion, the second portion being pivotable around the forward mounting around a transverse axis between an operating position in which the second portion is attached to the first portion forming a continuous pan surface, and a lowered position in which the second portion is detached from the first portion to give maintenance access to the underside of the separating apparatus.
